(19) United States
(12) Patent Application Publication
(10) Pub. No.: US 2013/0091431 A1
(43) Pub. Date: Apr. 11, 2013

(54) VIDEO CLIP SELECTOR

(71) Applicants: Keren MASTER, Kfar Saba (IL); Guy MERIN, Einhod (IL); Igor ABRAMOVSKI, Haifa (IL); Inbal ORT, Aseret (IL)

(72) Inventors: Keren MASTER, Kfar Saba (IL); Guy MERIN, Einhod (IL); Igor ABRAMOVSKI, Haifa (IL); Inbal ORT, Aseret (IL)

(73) Assignee: Microsoft Corporation, Redmond, WA (US)

(21) Appl. No.: 13/253,068

(22) Filed: Oct. 5, 2011

(51) Int. Cl. G06F 3/00; H04N 9/80

(52) U.S. Cl. 715/719; 386/241; 386/E09.011

(57) ABSTRACT

A video previewing and selection system may allow a user to filter and select video clips based on metadata associated with the video clips, including metadata that defines when certain people are shown in the clips. A set of video sequences may be analyzed to extract existing metadata and present the metadata in a user interface. A user may select various metadata which may be used to filter the selections using logical AND and OR combinations. The user interface may allow a user to view the clips, as well as select clips for further editing by a video editor.

### BACKGROUND

Many home users have many video clips, but find it difficult to select and edit clips to form into movies. Because storage is low cost and it is easy to take many movies, a home user may create lots of movies, but viewing and editing the movies is time consuming and frustrating.

### SUMMARY

A video previewing and selection system may allow a user to filter and select video clips based on metadata associated with the video clips, including metadata that defines when certain people are shown in the clips. A set of video sequences may be analyzed to extract existing metadata and present the metadata in a user interface. A user may select various metadata which may be used to filter the selections using logical AND and OR combinations. The user interface may allow a user to view a portion of the clips, as well as select clips for further editing by a video editor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with video browsing and selection system.

FIG. 2 is an example user interface diagram illustration of an embodiment showing a user interface for browsing and selecting video clips.

FIG. 3 is a flowchart of an embodiment showing a method for selecting videos for editing.

### DETAILED DESCRIPTION

A video previewing and selection system may display tagged videos so that a user can view and select clips based on the tags. In a typical use scenario, videos may be tagged with the persons shown in the videos, and the system may display all of the video clips containing a selected person. A user may view the clips, then move one or more of the clips into a storyboard to create a video movie.

The tagged videos may contain metadata that defines when certain users may be shown in a video. The tags may be defined in many different manners, but some embodiments may include the beginning and ending frames of a video where a certain person may be shown.

The system may display a list of people shown in the various videos and allow a user to select one or more people from the list. With each selection, the clips containing those people may be displayed for the user. The user may select one of the clips to display on a video player, or may select a clip to move to a storyboard. The storyboard may be used to place the clips in order, then to create a video comprising the clips. In some embodiments, the clips may be sent to a video editing system for further editing.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

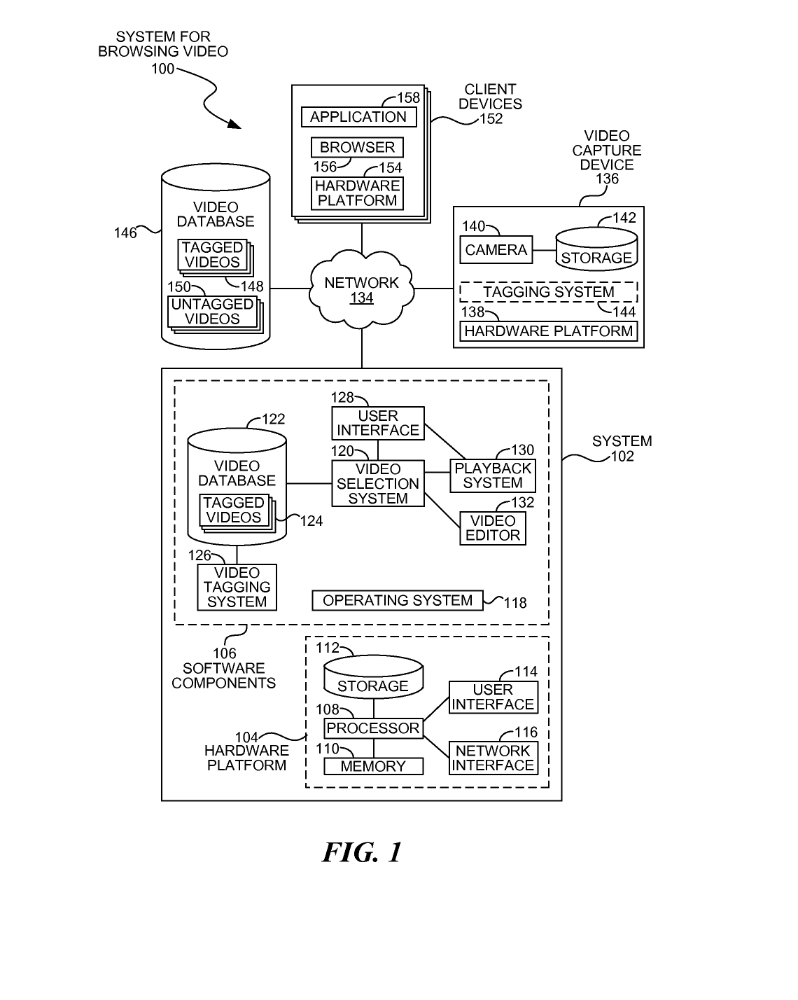

FIG. 1 is a diagram of an embodiment 100, showing a system 102 that may be used to browse and edit video using metadata. Embodiment 100 is a simplified example of a network environment in which various devices may operate to capture and edit video.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a network environment in which a system for browsing videos and video clips may operate. The system 102 may be a personal computer, for example, on which a user may browse videos. The video browsing system may have a user interface in which a user may be able to select video clips that contain specific people, when the videos have been tagged with metadata that identifies the people in the video.

Some embodiments may have a tagging system that may analyze a video to identify people within the video. The tagging system may first identify faces within the video, then attempt to identify the people represented by the faces. The tagging system may match images within the video to images within a user's social network contacts or other database to identify a face with a specific person.

The tagging system may add metadata to a video that includes identifiers where the video contains specific people. In some embodiments, the metadata may include the starting frame where the person appears. Some embodiments may also include the ending frame. In embodiments where the starting and ending frames may be identified, the system may thereby identify a clip that contains the person. In some embodiments, the tagging system may identify each frame where a person appears.

For home video enthusiasts, a user may take a large amount of video that may be difficult to edit because much of the video may not have much, if any, metadata. Consequently, the user may have many hours of video but may not have the time or patience to view all of the video to find a certain portion.

The tagging system may analyze many hours of a user's video to identify where various people are shown in the video. The tagging system may first identify faces in the video, then determine whose faces they are. Some tagging systems may be fully automatic, and may label people by matching static images of tagged people with the faces recognized in the video. Other tagging systems may have a human operator that manually identifies people that are identified in the video.

In some embodiments, a user may manually view the video and add tags.

The tagging system may add any type of content-related metadata, in addition to which people are shown in the video. Content-related metadata may include any metadata that may describe the contents of the video, such as the objects in the video, scenery, animals, as well as people. The content-related metadata may be used by a video browsing system to identify portions of the video to view and browse. From the browsing activities, clips of the video may be added to a storyboard for composing a movie.

Some videos may also be tagged with non-content metadata. Some systems may tag videos based on location, compass heading, date and time, or other metadata.

After the video is tagged, a browsing and display system may gather several videos together and analyze the metadata associated with the videos. The metadata topics may be gathered and displayed. A user may be able to select one or more of the metadata topics and the clips associated with the topics may be displayed in another potion of the user interface. The user may be able to select and view the various clips, then drag and drop the clips into a storyboard.

The displayed clips may be shown using a logical AND or logical OR to combine multiple selections. A logical OR selection may show all the clips that contain any of the selections. In an example where two metadata items are selected, the logical OR selection will contain any clip that contains either of the two items. In contrast, a logical AND selection may include only those clips that contain both of the two items. The clips may be generated on-the-fly as the user may change the filter criteria selections.

The metadata presentation and selection mechanism may allow a user to browse through tagged video very quickly to find clips that contain the tagged items of interest. Such systems remove much of the tedium of searching for specific subjects in many hours of video and may make creating movies enjoyable.

The system of embodiment 100 is illustrated as being contained in a single system 102. The system 102 may have a hardware platform 104 and software components 106.

The system 102 may represent a server or other powerful, dedicated computer system that may support multiple user sessions. In some embodiments, however, the system 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include user interface devices 114. The user interface devices 114 may include keyboards, monitors, pointing devices, and other user interface components.

The hardware platform 104 may also include a network interface 116. The network interface 116 may include hardwired and wireless interfaces through which the system 102 may communicate with other devices.

Many embodiments may implement the various software components using a hardware platform that is a cloud fabric. A cloud hardware fabric may execute software on multiple devices using various virtualization techniques. The cloud fabric may include hardware and software components that may operate multiple instances of an application or process in parallel. Such embodiments may have scalable throughput by implementing multiple parallel processes.

The software components 106 may include an operating system 118 on which various applications may execute. In some cloud based embodiments, the notion of an operating system 118 may or may not be exposed to an application.

A video selection system 120 may generate a user interface 128 from which a user may view and manipulate tagged videos. The video selection system 120 may retrieve tagged videos 124 from a video database 122.

The tagged videos 124 may have metadata that defines different aspects about the contents of the video. In particular, some of the metadata may define beginning and ending points of clips within a video that contains a particular content, such as a specific person. The video selection system 120 may analyze the tagged videos 124 to determine the metadata in the video, and then present portions of the video that correspond to the metadata.

In some embodiments, the video selection system 120 may have a playback system 130 that may show a selected video or video clip, as well as a video editor 132 with which a user may edit or further manipulate the videos and video clips.

Throughout this specification and claims, the terms “video” and “video clips” are used interchangeably, but in general the term “video” relates to a single file that contains a video sequence. The term “video clip” relates to a subset or portion of a video. In many cases, the operations performed on a video clip may also be performed on a video, and vice versa.

A video tagging system 126 may receive videos or video clips and tag the videos with metadata identifying the content within the video. In some embodiments, a video tagging system may be fully automated, while other systems may be semi-automated or manual systems.

The system 102 may be connected to a network 134 and to several other devices. In some cases, a video capture device 136 may connect to the system 102, as well as a video database 146, and various client devices 152.

The video capture device 136 may be any type of device that may generate video images. In many cases, the video capture device 136 may be a video camera, but may also be a cellular telephone or any other device that contains a video camera. The video capture device 136 may include a hardware platform 138, a camera 140, and video storage 142.

In some embodiments, the video capture device 136 may include a tagging system 144 that may automatically or semi-automatically tag video with metadata relating to the contents of the video, along with other metadata.

A video database 146 may be a repository available over a network 134 that contains tagged videos 148 and untagged videos 150. The video database 146 may be a storage system, computer, or other device that contains videos and may be accessed by the system 102 to display and manipulate the videos.

In the case of untagged videos 150, the system 102 may create the tag metadata using a video tagging system 126 prior to showing or manipulating the video with the video selection system 120.

The client devices 152 may be any type of device that may access the system 102 over the network 134. In some embodiments, the client devices 152 may use an application 158 or browser 156 to access the user interface 128 generated by the system 102.

Such embodiments may present the user interface 128 using HTML or other format that can be read by a browser 156 or application 158. In such embodiments, a user may operate the client device 152 to access the system 102, where the system 102 may do much of the processing for the video selection system 120. Such an embodiment may be useful when the client device 152 may not have the processing power, storage, or other bandwidth to perform the operations of the video selection system 120 or other components of the system 102.

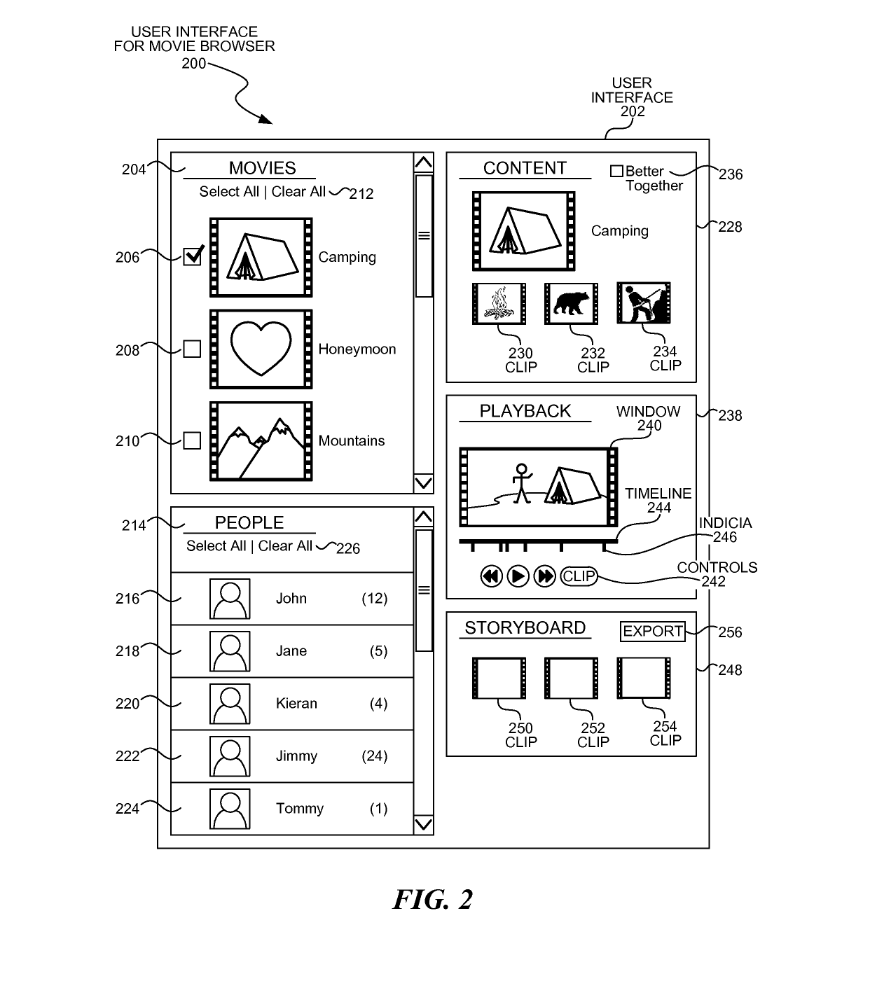

FIG. 2 is a diagram illustration of an embodiment 200 showing a user interface 202 that may be used for browsing and selecting video clips. Embodiment 200 is merely one example of a user interface that may include features that allow a user to select clips based on metadata, view the clips, and place the clips into a storyboard for further editing.

In the area 202, a listing of video files may be presented to the user. The video files may be loaded into the system by the user, or may be identified by the system by searching various folders or directories for video files. In some embodiments, the system may be capable of viewing many different video file formats.

In the area 202, several different movies are displayed. The list of movies may include “camping” 206, “honeymoon” 208, “mountains” 210, and others. Each of the movies may be displayed with an image that may represent the video.

The movie “camping” 206 is shown as selected. Because the movie “camping” 206 is selected, the video clips may all be taken from this video. In some cases, a user may select several video files from which video clips may be taken.

In the section 214, a listing of people may be displayed. The people may be culled from the videos by identifying metadata in the video. For each of the people 216, 218, 220, 222, and 224, a representative image of the person along with the person's name and number of video clips are shown.

The user interface 202 may allow a user to select one or more of the people. In the example of embodiment 200, people 216 and 220 may be selected.

When the people are selected, the content section 228 may show various video clips 230, 232, and 234. The video clips 230, 232, and 234 may show any clip that contains either person 216 or 220. Such an example may be a logical OR combination.

Some embodiments may have a toggle 236 that may change the logical OR combination to a logical AND combination. The toggle 236 may be labeled “better together” and may show videos that contain both person 216 and 220 in the same clip.

The user may select any video or video clip for display in the playback area 238. The playback area 238 may include a window 240 for displaying the selected video or video clip, as well as a set of controls 242 for starting, stopping, and otherwise controlling the playback.

The playback area 238 may include a timeline 244 that displays the time covered by a video. Various indicia 246 may indicate where certain people are shown in the video. When a user selects a video clip 230, 232, or 234, the playback area 238 may show the timeline 244 representing the entire video, and may start the playback at one of the indicia 246 that represents the starting point of a video clip. The user may also view the entire video. In some embodiments, the playback area 238 may allow the user to jump between filtered clips that show only the video clips that meet the selected filter criteria.

The timeline 244 and the various indicia 246 may give the user visual clues as to where the video clips are located in the sequence of the overall video. The visual clues may help a user identify the video clip when the user is searching for a specific clip.

A storyboard area 248 may include various clips 250, 252, and 254 that the user may have placed in the storyboard area 248. The storyboard area 248 may contain video clips that may be organized in a sequence that may be combined into a movie.

In some embodiments, a user may be able to select video clips by selecting a movie, person, then selecting an associated clip which may be placed in the storyboard. The clip may be stored in the storyboard while the user selects a second movie, a different person, and then selects another clip to move to the storyboard.

Once the user has completed adding clips to the storyboard area 248, the user may use an export button 256 to export the clips to an editing system. Within the editing system, the user may be able to further manipulate the clips into a movie.

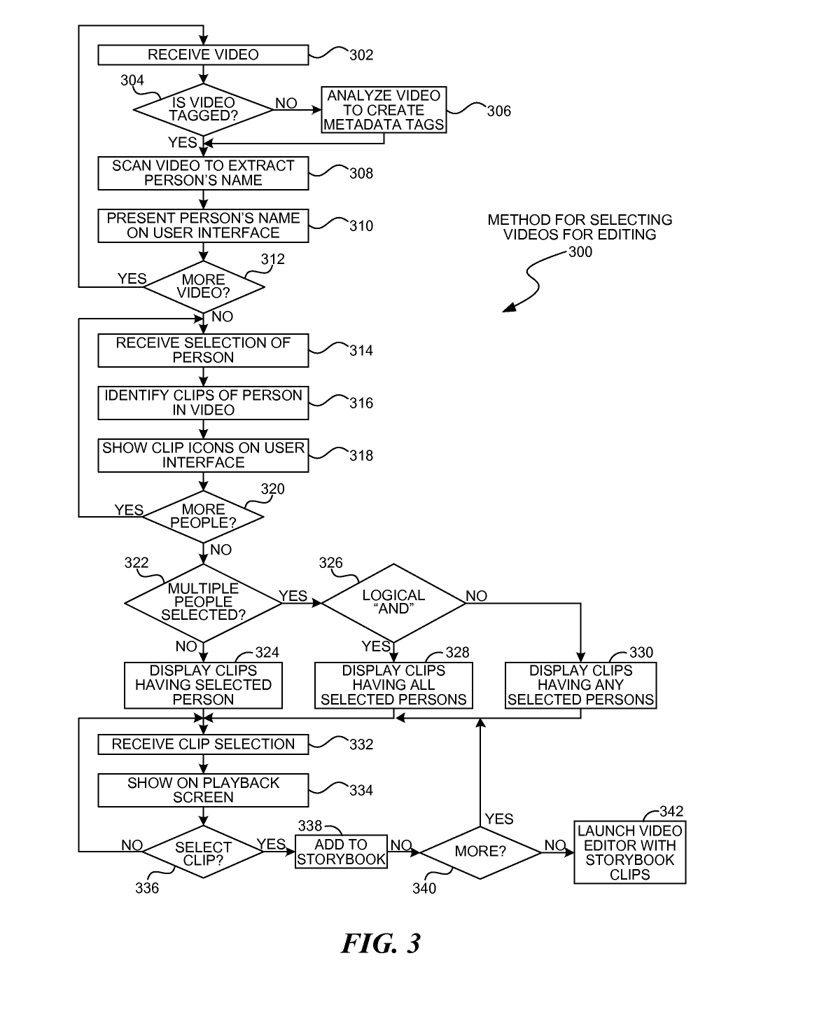

FIG. 3 is a flowchart illustration of an embodiment 300 showing a method for selecting videos to edit. Embodiment 300 is a simplified example of a method that may be performed by a video selection system, such as the video selection system 120 of embodiment 100. The operations of embodiment 300 may also be performed by a user operating the user interface 202 of embodiment 200 in some cases.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, a video may be received. The video may be selected from a database of videos, which may be a folder or directory system in which videos may be stored. If the video is not tagged in block 304, the video may be analyzed in block 306 to create metadata tags. The metadata tags may represent the starting points for certain content within the video, such as the appearance of a certain object or person. In some embodiments, the metadata tags may include the stopping points within the video for the tagged object.

The video may be scanned in block 308 to extract the metadata. In many cases, the metadata may be a person's name. The metadata may be presented to the user in block 310.

If more videos are to be added in block 312, the process may return to block 302 to add another video. If not, the process may continue.

In block 314, the selection of a person or other tagged metadata may be received. Video clips containing the person or other tagged object may be identified in block 316 and shown on a user interface in block 318.

If more people or other tagged object are to be selected in block 320, the process may return to block 314. If not, the process may continue.

When only one person is selected in block 322, the clips containing the person or tagged object are displayed in block 324.

If more than one person or tagged object is selected in block 322, and the logical AND selection is made in block 326, clips containing all of the selected persons or tagged objects may be presented in block 328. If the logical AND is not selected in block 326, clips containing any of the selected persons or tagged objects may be shown in block 330.

A clip selection may be made by the user in block 332. The clip may be shown on the playback screen in block 334. If the clip is further selected in block 336, the clip may be added to the storyboard in block 338. If more selections are made in block 340, the process may return to block 332.

In some cases, the user may view the clip in block 334 and may decide not to add the clip to the storyboard in block 336. In such a case, the process may return to block 332.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a database comprising tagged video, said tagged video comprising metadata indicating people shown in video;
a video selection system that:
receives a selection of tagged video;
scans said tagged video to determine metadata from tags associated with said tagged video;
presents said metadata in a user interface as selectable options;
receives a selection for a first metadata item, and presents said tagged video having said first metadata item.

2. The system of claim 1 further comprising:
a video preview system that receives a selection of one of said tagged video and previews said tagged video in a player.

3. The system of claim 2, said video selection system that further:
receives a selection for a second metadata item; and
presents said tagged video having both said first metadata item and said second metadata item.

4. The system of claim 3, said video selection system that further:
receives a selection for a first tagged video clip; and
stores said selection for a first tagged video clip for transfer to a video editor.

5. The system of claim 4, said first tagged video clip comprising tags for a beginning frame and an end frame within said first tagged video clip where a first person is shown.

6. The system of claim 5, said video editor receiving said first tagged video clip and said tags.

7. The system of claim 1, said metadata comprising tags for people identified using facial recognition.

8. The system of claim 7, said metadata comprising global tags for said video clips.

9. The system of claim 1, said tagged video comprising clips showing a single scene.

10. The system of claim 9, said tagged video comprising movies comprising a plurality of scenes.

11. The system of claim 10, said presents said tagged video having said first metadata item comprising presenting a timeline for said tagged video with indicia for said metadata item indicated on said timeline.

12. A method comprising:
receiving tagged video clips having metadata, said metadata comprising tags indicating start frames and end frames where a person appears, said tags further indicating said person's name;
scanning said tagged video clips to extract said metadata;
presenting said person's name on a user interface; and
receiving a selection for a first person's name and presenting at least one of said tagged video clips comprising said first person.

13. The method of claim 12 further comprising:
presenting a list of people's names with a number of video clips where said people's names appear.

14. The method of claim 13 further comprising:
receiving a selection for a second person's name and presenting at least one of said tagged video clips where said first person and said second person appear at the same time.

15. The method of claim 12 further comprising:
said at least one of said tagged video clips being cued to start playing where said first person is shown in said video clip.

16. The method of claim 15 further comprising:
selecting a first video of said tagged video clips comprising said first person; and
transferring said first video to a movie editing system with said tags.

17. An interactive user interface operable on a computer processor, said user interface comprising:
a video selection component displaying at least one video identifier, said video selection component receiving a video selection;
a person selection component displaying at least one person identifier, said person selection component receiving a selection for a first person; and
a content component displaying video clips from said video selection, said video clips containing said first person.

18. The user interface of claim 17 further comprising:
a playback component that plays a selected clip.

19. The user interface of claim 18, said playback component comprising a timeline, said timeline comprising indicia that indicate where said first person is shown in said selected clip.

20. A computer readable storage medium not comprising a transitory signal, said medium comprising computer executable instructions for creating said user interface of claim 17.
